(19) United States
(12) Patent Application Publication
(10) Pub. No.: US 2022/0165102 A1
(43) Pub. Date: May 26, 2022

(54) SENSING APPARATUS AND CONTROL SYSTEM FOR AUTOMOTIVE

(71) Applicant: Sony Group Corporation, Tokyo (JP)

(72) Inventor: Dietmar SCHILL, Stuttgart (DE)

(73) Assignee: Sony Group Corporation, Tokyo (JP)

(21) Appl. No.: 17/440,796

(22) PCT Filed: Mar. 18, 2020
(86) PCT No.: PCT/EP2020/057519

§ 371 Date: Sep. 20, 2021

(30) Foreign Application Priority Data
Apr. 24, 2019 (EP) 19170739.7

(51) Int. Cl. G07C 5/08; G06V 10/25; G06T 1/00; H04N 7/01; H04N 7/18; G06V 10/82; G06V 20/56; H04N 19/42; B60W 60/00; B60W 50/14; G06N 3/04

(52) U.S. Cl. CPC G07C 5/085; G06V 10/25; G06T 1/0014; H04N 7/01; H04N 7/183; G06V 10/82; B60W 2050/146; H04N 19/42; B60W 60/001; B60W 50/14; G06N 3/04; B60W 2420/42; G06V 20/56

(57) ABSTRACT

The present disclosure relates to a sensing apparatus comprising a sensor configured to generate a sensor data stream having a first data rate, a data processing circuitry configured to interpret the sensor data stream to generate an interpreted sensor data stream having a second data rate lower than the first data rate as a pre-processed data for a process based on an artificial neural network at a central processing apparatus, and a transmitter configured to transmit the interpreted sensor data stream from the sensing apparatus to the central processing apparatus. A further example relates to a control system for automotive comprising a sensing apparatus and a central processing apparatus connected to the sensing apparatus via a data bus.

### FIELD

The present disclosure relates to sensing apparatuses and control systems for automotive such as driver assistance systems comprising sensing apparatuses. Further examples of the disclosure relate to vehicles comprising at least one sensing apparatus or a control system for automotive.

### BACKGROUND

In modern vehicles, environmental sensors are used for autonomous driving functions, for example. Sensors like image sensors, radar sensors or lidar sensors screen the environment and provide information about objects around the vehicle.

For a better functionality of autonomous or semi-autonomous vehicles including e.g. an advanced driver assistance system, improved sensors may be required. A higher number of sensors or sensors with increased performance provided in the vehicle may improve the detection of objects in the environment of the vehicle or a street course for the vehicle. The processing of sensor data, for example of a plurality of sensors may be realized in a central processing unit of the vehicle. Object recognition in the environment may be based on the combined sensor data of the plurality of sensors, e.g. by use of artificial intelligence algorithms and neural networks. The single sensors may be connected with the central processing unit via a data bus of the vehicle to form a sensor system.

However, high performance environmental sensors generate sensor data having a high data rate. For example, a data transmission capacity of the data bus of the vehicle may not meet the requirements for the high data rate sensor signals of all of the sensors. For example, transmitting the high data rate sensor signals to the central processing unit may cause increased power consumption.

One possibility could be to use data compression algorithms for reducing a quality of the sensor signals before transmitting the sensor data to the central processing unit. However, by compression of e.g. video data of an image sensor, an image quality will be reduced, and consequently important information about the environment could be lost. For example, machine vision applications may generate less reliable output when using video signals with reduced video quality. For example, when using such data compression, it may not be possible to use the full available performance of the environmental sensors of the vehicle. Thus, it might not be possible to e.g. further improve functionalities for autonomous driving of the vehicle.

There may be a need for concepts that enable the use of high performance environmental sensors in a vehicle while limiting or reducing requirements relating to a data transmission capacity of a data bus of the vehicle.

### SUMMARY

This need is met by the subject matter in accordance with the independent claims. Advantageous embodiments are addressed by the dependent claims.

An example of the present disclosure relates to a sensing apparatus, e.g. a semiconductor package. The sensing apparatus comprises a sensor configured to generate a sensor data stream having a first data rate. Further, the sensing apparatus comprises a data processing circuitry configured to interpret the sensor data stream to generate an interpreted sensor data stream having a second data rate lower than the first data rate as a pre-processed data for a process based on an artificial neural network at a central processing apparatus (e.g. a central device or central processing device). Further, the sensing apparatus comprises a transmitter configured to transmit the interpreted sensor data stream from the sensing apparatus to the central processing apparatus.

A proposed sensing apparatus may be used for a distributed or decentralized sensor network, e.g. of a sensor system of a vehicle. The sensing apparatus may be configured for usage in a control system for automotive, e.g. an advanced driver assistance system. The sensor system may comprise a plurality of sensing apparatuses and a central processing device, for example. Sensor data of the sensor (e.g. environmental sensor) of the sensing apparatus may be pre-processed by a processor within the sensing apparatus, e.g. comprising a neural network, e.g. a sub-network of a neural network of the sensor system. Pre-processing the sensor data at the sensing apparatus enables transmitting the pre-processed sensor data, e.g. the interpreted sensor data stream, instead of primary sensor data, e.g. having a higher data rate.

For example, the neural network of the sensor system may be distributed between the central processing device and the sensing apparatus or the plurality of sensing apparatuses. In other words, the artificial neural network may be spilt and divided into a number of subnetworks provided in separate electrical circuitry. Transmitting the interpreted sensor data stream may reduce requirements on a data transmission capacity, for example while at the same time enabling to use the full performance of the sensor of the sensing apparatus, for example for machine vision or object recognition.

A further example of the disclosure relates to a control system for automotive (e.g. driver assistance system) comprising at least one proposed sensing apparatus. The control system for automotive further comprises a central processing device connected to the sensing apparatus via a data bus for receiving at least the interpreted sensor data stream from the sensing apparatus. The central processing device is configured to generate a driving instruction based on at least one interpreted sensor data stream.

In a proposed control system for automotive, for example high performance sensors generating high data rate sensor signals may be used while a requirement on a data transmission capacity of the data bus may be limited or reduced, for example. For example, it may be possible to transmit data of a higher number of sensors via a data bus by providing proposed sensing apparatuses.

An example according to the disclosure relates to a vehicle comprising at least one proposed sensing apparatus and/or a proposed control system for automotive.

For example, in a vehicle with an existing data bus for a data connection between sensors and a central processing device, the proposed sensing apparatuses may enable to use a higher number of sensors or sensors with increased performance without reaching a limit of a data transmission capacity of the data bus, for example.

### BRIEF DESCRIPTION OF THE FIGURES

Some examples of apparatuses and/or methods will be described in the following by way of example only, and with reference to the accompanying figures, in which

FIG. 1 shows an example of a sensing apparatus with a sensor and data processing circuitry;

FIG. 2 shows an example of a control system for automotive comprising one or more sensing apparatuses;

FIG. 3 shows a schematic block diagram of a system comprising a plurality of sensing apparatuses;

FIG. 4 shows an example of a vehicle comprising a control system for automotive with a sensing apparatus;

FIG. 5 shows an example of a vehicle comprising a control system for automotive with a sensing apparatus and transmission of a reduced quality video stream;

FIG. 6 shows a schematic view depicting a configuration of a stacked image sensor;

FIG. 7 shows a schematic block diagram depicting a configuration example of peripheral circuits;

FIG. 8 shows a schematic perspective view illustrating an exemplary configuration of a solid-state imaging device; and

FIG. 9 shows a layout diagram illustrating an exemplary layout of a layered chip in the solid-state imaging device.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

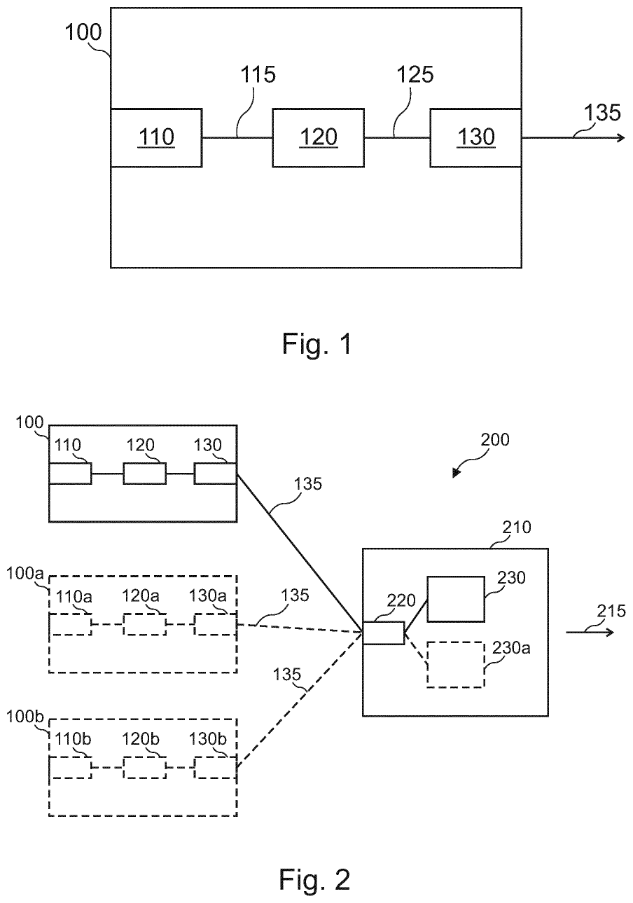

FIG. 1 shows an example of a sensing apparatus 100 (e.g. a semiconductor package). The sensing apparatus 100 comprises a sensor 110 configured to generate a sensor data stream 115 having a first data rate. The sensing apparatus 100 further comprises a data processing circuitry 120 configured to interpret the sensor data stream 115 to generate an interpreted sensor data stream 125 having a second data rate lower than the first data rate. The interpreted sensor data stream 125 is provided as a pre-processed data for a process based on an artificial neural network at a central processing apparatus. Further, the sensing apparatus 100 comprises a transmitter 130 configured to transmit the interpreted sensor data stream 125 from the sensing apparatus 100 to the central processing apparatus.

For example, the semiconductor package 100 (e.g. semiconductor package) may be provided in a sensor system of a vehicle. The vehicle may be an autonomous or a semiautonomous vehicle, for example driver assistance functions may be provided by the vehicle. For example, driving instructions may be generated based on the sensor data at a central processing device of the sensor system, for example the central processing apparatus to which the transmitter 130 of the sensing apparatus 100 transmits the interpreted sensor data stream 125. The interpreted sensor data stream 125 may be transmitted to the central processing device via a data bus 135, for example.

The sensor system may for example enable machine vision or object recognition within an environment around the vehicle. For example, the sensor 110 of the sensing apparatus 100 is an environmental sensor, e.g. configured for machine vision applications. For example, the interpreted sensor data stream 125 may be configured for use in a machine vision application. The sensor data of the sensor 110 is processed by electrical circuitry, e.g. at least partly the data processing circuit 120, comprising a neural network, for example. The neural network may be an artificial neural network such as a deep neural network DNN or a compact deep neural network, for example. The neural network may use the information of the sensor data of the sensor 110 of the sensing apparatus 100 or a plurality of sensors of a plurality of sensing apparatuses for detection of objects and/or generation of driving instructions, for example. For example, within the central processing device, a first part of the neural network is provided, e.g. at the data processing circuitry 120. The interpreted sensor data stream 125 may comprise Meta data, abstract data, and/or an intermediate data representation of the sensor data, for example.

The sensor 100 e.g. is a high performance sensor generating a sensor data stream 115 having a high data rate, for example primary or uncompressed sensor data. The sensor data stream may comprise important information relating to the environment of the vehicle that may be required for improved object recognition, for example. Therefore, for machine vision applications, a compression of the sensor data stream, for example resulting in a reduced image quality of images of an image sensor 110, should be avoided before processing the sensor data stream or the primary sensor data by the neural network. For example, the data rate of the sensor data stream 115 may be too high for being transmitted via the data bus 135, for example due to a risk of an overload of the data bus 135.

By providing the data processing circuitry 120 within the sensing apparatus 100, it is possible to provide a neural network within the sensing apparatus 100, for example at least a part of a neural network of a system that comprises the sensing apparatus 100. Interpreting the sensor data stream 115 may comprise processing the sensor data stream 115 by the neural network of the data processing circuitry 120. For example, the data processing circuitry 120 comprises a first sub-network of a neural network of the sensor system of the vehicle. For example, the central processing device of the system the sensing apparatus 100 is used for (see also FIG. 2) comprises a second sub-network of the neural network. Hence, the neural network of the sensor system may be distributed between the sensing apparatus 100 and the central processing device. The sensing apparatus 100 or the data processing circuitry 120 may comprise a part of a decentralized artificial neural network.

By providing the artificial neural network within the sensing apparatus 100, the sensor data stream 115, e.g. uncompressed sensor data of the sensor 110, can be processed by the artificial neural network without a need for transmitting the high data rate sensor data stream 115 to the central processing apparatus, for example. Processing the sensor data stream 115 by the artificial neural network or first layers of the artificial neural network, for example, may result in a reduction of a data rate. For example, the data rate of the interpreted sensor data stream 125 that may be generated by processing the center data stream 115 using the neural network of the sensing apparatus 100, is lower than the data rate of the sensor data stream 115 comprising uncompressed sensor data, for example.

Providing the data processing circuitry 120 within the sensing apparatus 100 may enable processing uncompressed sensor data of the sensor 110 by a neural network, for example a neural network of a distributed sensor system, while avoiding transmitting the uncompressed sensor data at a high data rate, for example via a data bus. Compared to other concepts that use data compression before sending the sensor data from the sensor to a central neural network at a lower data rate, by providing the sensing apparatus 100 the sensor data may be used at full data rate by the neural network without the need of transmitting the sensor data at full data rate to the central processing device.

For example, the sensing apparatus 100 may be provided in a distributed sensor system of a vehicle, for example enabling autonomous driving functions. Providing the data processing circuitry 120 may enable to avoid the transmission of data of the sensor (e.g. an image sensor) with large image data rates, thus reducing power consumption due to data transmission and/or transmission costs, for example. For example, signal processing employing neural networks, may be done decentralized at least partly within the sensing apparatus, for example with a high or full frame rate and/or a high or full resolution of the sensor. Consequently, it may be possible to use standard communication interfaces, for example data buses, while using sensors having higher resolution and higher frame rate, for example. At the same time, while increasing a system performance, for example overloading the data bus may be avoided.

By using proposed concepts of the present disclosure, a required data rate of an interface between a sensor and a central unit may be reduced. For example, the signal processing may make full usage of available high-performance image sensors. For example, costs and/or power consumption of proposed systems may be reduced as the interface may be a limiting factor. For example, improved image sensors may be provided in decentralized sensor systems. For example, integration of logical circuitry onto image sensors may be used. For example also a power requirement of the central unit may be reduced as a part of the signal processing may be outsourced to the sensing apparatus.

For example, the sensor 110 may comprise one of an image sensor, a multi-spectral sensor, a polarized image sensor, a time-of-flight sensor, a radar sensor, and a lidar sensor. The multi-spectral sensor may enable detection of a visible, a near infrared and/or an infrared spectrum. For example, the sensor may have more spectral lines in the visible spectrum, e.g. the sensor 110 may be configured to detect not only RGB but a higher number of colors separately. Such sensors may generate sensor data streams having a high data rate, for example. However, by providing the data processing circuitry 120 in the sensing apparatus 100 and pre-processing or interpreting the sensor data before transmission, it may be possible to use such high performance sensors, for example also in sensor networks with limited data transmission capacity.

The sensor 110, the data processing circuitry 120 and the transmitter 130 may be located in a common package, for example comprising a metal, plastic, glass and/or ceramic casing. For example, placing discrete semiconductor devices or integrated circuits in a common package may enable a compact dimension of the sensing apparatus. For example, at least the sensor 110 and a circuit comprising at least one first layer (e.g. a plurality of first layers) of the artificial neural network, e.g. the data processing circuitry 120, are integrated in a common semiconductor chip. Integrating the sensor 110 and the data processing circuitry may enable further miniaturization of the semiconductor package, for example. For example, also the transmitter 130 may be integrated within the common semiconductor chip.

For example, the sensor data is image based information, and the interpreted sensor data stream 125 includes information on an object from the image based information. For example, after pre-processing the sensor data stream 115 by the data processing circuitry 120, e.g. by a first sub-network of a neural network of a sensor system comprising the semiconductor package, it may not be possible to directly provide information about objects or enable object recognition. However, relevant information on the object may be included in the interpreted sensor data stream 125 that e.g. enables object recognition after further processing the interpreted sensor data stream 125, e.g. by a further sub-network of the neural network, e.g. provided at the central processing device comprising second layers of the neural network.

The interpreted sensor data stream 125 may be the state of an intermediate layer of a neural network, the state of an output layer of a neural network, and/or any intermediate result or output of a signal processing algorithm, for example. If the sensor data stream 115 is a video stream, it might not be possible to convert the interpreted sensor data stream 125 back to a video stream, for example. The interpreted sensor data stream 125 may be exclusively configured for use in machine vision, for example it cannot be used for displaying a video to a user.

For example, the sensor data is at least one of radar based information, lidar based information, polarized image sensor information, multispectral image sensor information, and time-of-flight-sensor based information, and the interpreted data stream 125 correspondingly includes information on an object from the at least one of radar based information, lidar based information, polarized image sensor information, multispectral image sensor information, and time-of-flight-sensor based information. As described before, object recognition may be enabled only after further processing the interpreted sensor data stream 125, e.g. by a sub-network of the artificial neural network comprising second layers of the neural network.

For example, the interpreted sensor data stream 125 may comprise information relating to at least one region of interest of the original sensor data. For example, regions of an image without relevant information for an application the interpreted sensor data stream 125 is used for (e.g. machine vision), may be deleted and not being transmitted. For example, only regions, e.g. image regions, comprising relevant information may be selected and transmitted. The interpreted sensor data stream 125 may comprise a set of regions of interest of the original sensor data (e.g. primary sensor data) in order to further reduce the data rate to be transmitted. For example, only several sections or regions of an image may be transmitted, e.g. if fast movement or other specific characteristics are detected within said sections or regions.

For example, the second data rate may be less than 40% (or less than 30%, less than 20%, less than 15%, less than 10% or less than 5%) of the first data rate. For example, preprocessing the sensor data stream 115 by a neural network of the sensing apparatus 100 may enable to reduce the data rate to be transmitted from the sensing apparatus to a central processing apparatus (e.g. central device) by a factor of 5, or a factor of 10 or more, compared to the data rate of the sensor data stream 115.

For example, the data rate of the sensor data stream 115 is at least 5 Gbit/s (or at least 6 Gbit/s, at least 7 Gbit/s, at least 8 Gbit/s or at least 10 Gbit/s) and/or at most 20 Gbit/s (or at most 15 Gbit/s, at most 10 Gbit/s or at most 9 Gbit/s). For example, a frame rate of the sensor is at least 50 frames per second (fps) (or at least 100 fps, at least 200 fps, at least 500 fps, or at least 1000 fps) and/or at most 2000 fps (or at most 1500 fps, at most 1000 fps, or at most 500 fps). For example, a resolution of the sensor is at least 6 megapixels (or at least 8 megapixels, at least 10 megapixels, at least 15 megapixels, or at least 20 megapixels). For example, high performance sensors with high resolution or frame rate resulting in a high sensor data rate may be used for machine vision applications or other distributed sensor systems by providing the sensing apparatus 100.

For example, the sensor 110 may be configured to provide a video stream and a video coder of the sensing apparatus is configured to reduce a quality of the video stream, wherein the sensing apparatus is configured to transmit the encoded video stream additionally to the interpreted sensor data stream. For example, additional to a neural network of the sensing apparatus, a conventional video coder or data compressor may be provided at the sensing apparatus 100. For example, the video coder may be provided at a same chip or processor as the neural network of the sensing apparatus 100. For example, by encoding a video stream of the sensor 110, a compressed video stream may be transmitted from the sensing apparatus 100 with a reduced data rate compared to a data rate of a primary video stream of the sensor 110. For example, in contrast to the interpreted sensor data stream 125, which might not be convertible to a video stream that can be displayed to a user, the compressed video stream may be decoded, e.g. by the central processing device, and displayed to the user. For example, the interpreted sensor data stream 125 may be used for machine vision, whereas the compressed video stream may be used to display a video or an image captured by the sensor 110 to the user. In contrast to machine vision applications, there may be no need to provide a video to the user at full frame rate or at full resolution of a high performance sensor, for example.

According to an aspect, a data compression unit may be located in a signal path between the artificial neural network and the transmitter 130. The data compression unit (e.g. a Huffman coder) is configured to further compress the data rate of the interpreted sensor data stream 125, for example. For example, the data processed by the data processing circuitry 120 or the neural network of the sensing apparatus may be further compressed by using a standard or conventional data compression algorithm. The data compression unit may be provided in a common chip with the data processing circuitry 120, for example.

For example, the sensing apparatus 100 is configured for use in a control system for automotive, e.g. an advanced driver assistance system of a vehicle. The advanced driver assistance system may enable autonomous driving of the vehicle, for example. For example, the advanced driver assistance system may provide active or passive safety functions. The vehicle may be a passenger car or a commercial vehicle, e.g. a truck, a motorcycle, a vessel or an aircraft, for example. For example, the vehicle may be an unmanned aerial vehicle, e.g. a drone.

FIG. 2 shows an example of a control system for automotive 200 (e.g. a driver assistance system) comprising at least one sensing apparatus 100. For example, the control system 200 may comprise a plurality of sensing apparatuses 100, 100a, 100b. Further, the control system 200 comprises a central processing device 210 connected to the at least one sensing apparatus 100 via a data connection, e.g. a data bus 135, for receiving at least the interpreted sensor data stream 125 from the sensing apparatus 100, e.g. at a receiving unit 220 of the central processing device 210. For example, the receiving unit 220 may be connected to the data bus 135 and all sensing apparatuses 100, 100a, 100b of the control system 200 may transmit at least interpreted sensor data streams 125 to the receiving unit 220.

For example, the central processing device 210 is configured to generate a driving instruction 215 based on at least one interpreted sensor data stream 125. For example, the driving instructions 215 generated by the central processing device 110 are based on data of at least two sensing apparatuses 100, 100a, or on data of all of the sensing apparatuses 100, 100a, 100b of the control system 200.

For example, the central processing device 210 may comprise data processing circuitry 230 and a neural network, for example a sub-network of the control system 200. The neural network of the central processing device 210 may be provided at a single processor, for example the data processing circuitry 230, or may be distributed between at least two processors, for example the data processing circuitry 230 and further data processing circuitry 230a. For example, the central processing device 210 comprises at least two processors 230, 230a, wherein each of the processors of the central processing device 210 comprises a subnetwork of the neural network of the central processing device 210 or of the control system 200, for example.

For example, the control system 200 may comprise a neural network or a distributed neural network comprising at least two sub-networks. The artificial neural network of the sensing apparatus 100 is provided as a first sub-network of the neural network of the system 200, and a second sub-network of the neural network is provided in the central processing device 210. Hence, the sensor data stream 115 of the sensor 100 can be pre-processed by the neural network (e.g. first layers of the neural network of the system) of the sensing apparatus 100, transmitted to the central processing device 210, and be further processed by the neural network (e.g. second layers of the neural network of the system) of the central processing device 210. The whole neural network of the control system 200, e.g. comprising all subnetworks of the sensing apparatuses and the central processing device 210 may be used to generate the driving instruction 215, for example.

For example, if two or more data processing circuits 230, 230a are provided, a first data processing circuit 230 may receive interpreted sensor data streams 125 of a first number of sensing apparatuses, and a second data processing circuit 230a may receive an interpreted sensor data stream 125 of a second number of sensing apparatuses. For example, output data of the data processing circuits 230, 230a may be transmitted to a further data processing circuit (not shown in FIG. 2) to merge the processed data of the data processing circuits 230, 230a, e.g. by use of third layers of the neural network of the control system 200. For example, in this way the neural network may be further distributed which may enable further reduction of data to be transmitted within the system.

It may be possible to train the at least two sub-networks of the neural network, for example the artificial neural network of the sensing apparatus 100 and the artificial neural network of the central processing device 210, separately or together. For example, for a training of the neural network of the control system 200, all sensing apparatuses of the control system 200 may be connected to the central processing device 210 so that the whole neural network of the control system 200 can be trained simultaneously. Alternatively, for example if the neural network of the sensing apparatus 100 is trained separately, the sensing apparatus 100 may be provided more flexibly to any control system (e.g. driver assistance system), for example comprising a separate neural network, e.g. a central sub-network.

As mentioned before, the control system 200 may comprise a plurality of sensing apparatuses 100, 100a, 100b. The neural network of the control system 200 may comprise a plurality of sub-networks, wherein each of the sensing apparatuses 100, 100a, 100b may comprises a sub-network of the neural network. For example, in different sensing apparatuses, a same number of layers of the neural network may be realized to provide the sub-network. Alternatively, a number of layers of the sub-network within a sensing apparatus 100 may be adapted e.g. according to a type of sensor 110 that is provided in the sensing apparatus 100.

Two or more of the sensor packages, e.g. the sensing apparatuses 100, of the system 200 may each have a part of a total or overall artificial neural network of the system. Together with the neural network part in the central unit, e.g. the sub-network of the neural network at the central processing device 210, the overall neural network may be formed, for example.

For example, the control system 200 (e.g. driver assistance system) may further comprise a display, wherein at least one sensing apparatus 100 of the control system 200 comprises an image sensor 110 configured to provide a high quality video stream. The sensing apparatus 100 is configured to output a reduced quality video stream (e.g. compressed video stream with reduced resolution and/or frame rate) based on the high quality video stream, wherein the system is configured to show the reduced quality video stream on the display.

The video stream transmitted to the central processing device 210 may be used to display the video to the user and/or further, to provide an additional safety function for an autonomous driving function, for example. Although the video stream may have a reduced video quality, it may be used as additional security layer for generating driving instructions, for example. Information from the video stream may be used to generate driving instructions, for example if a malfunction of the neural network is detected and/or if driving instructions generated by the neural network differ from driving instructions generated based on the video stream, for example.

For example, the reduced resolution video stream or video streams of a number of sensing apparatuses may be an input to a non-neural network based control algorithm at the central processing unit 210, e.g. with the task to control a correct operation of the neural network. For example, the control algorithm can check whether the control commands from the neural network to vehicle actuators are within reasonable bounds. If unusual commands are detected, safety functions may be activated or the driver may be informed and/or may be asked to control the vehicle manually, for example.

For example, the data bus 135 between the sensing apparatus 100 and the central processing device 210 is configured for transferring a maximum data rate that is lower than the data rate of the sensor data stream 115 of the sensor 110 of the sensing apparatus. For example, the maximum data rate that can be transmitted via the data bus 135 is lower than the amount of data rates of sensor data streams of all sensing apparatuses 100, 100a, 100b of the system 200.

For example, the system 200 comprises at least one neural network based processing circuitry (e.g. a neural processor), e.g. the data processing circuitry 120 and the processor 230, and at least one conventional processing circuitry. A neural processor or a neural processing unit (NPU) may be a microprocessor that specializes in the acceleration of machine learning algorithms, for example by operating on predictive models such as artificial neural networks (ANNs) or random forests (RFs). The conventional processing circuitry may be a standard microprocessor (μC) or central processing unit (CPU), for example. The conventional processing circuitry may comprise a video decoder, for example. For example, for some functionalities of the system 200, a neural network may be required, whereas other functions of the driver assistance system, such as video decoding, may be based on conventional algorithms.

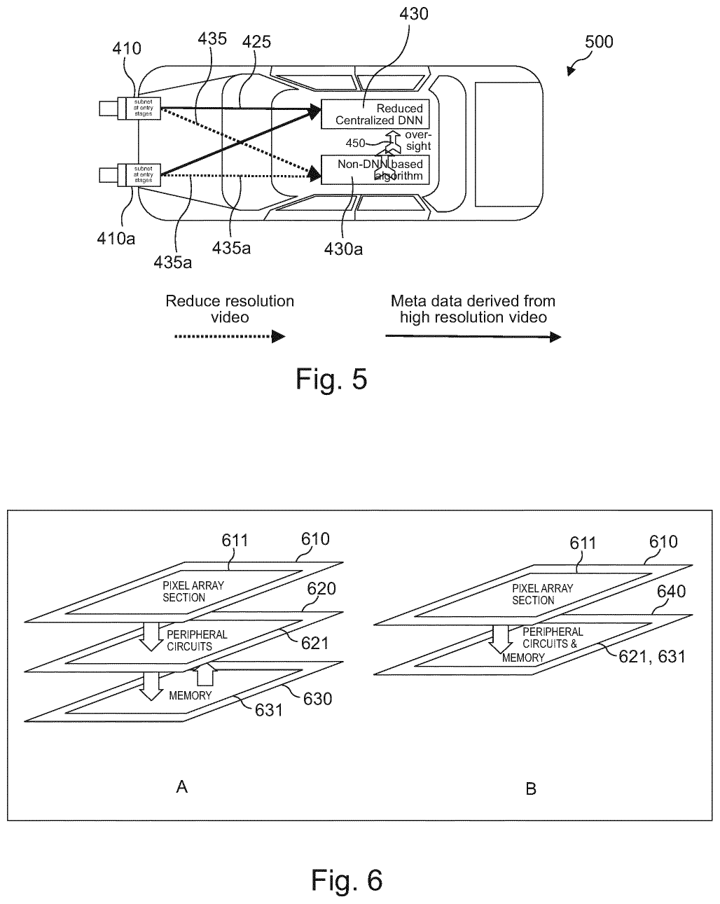

A further aspect of the disclosure relates to a vehicle (see e.g. FIGS. 4 and 5) comprising at least one sensing apparatus 100 and/or a system 200 as described above or below.

More details and aspects are mentioned in connection with the embodiments described above or below. The embodiments shown in FIG. 2 may comprise one or more optional additional features corresponding to one or more aspects mentioned in connection with the proposed concept or one or more embodiments described above (e.g. FIGS. 1 and 3-9) or below.

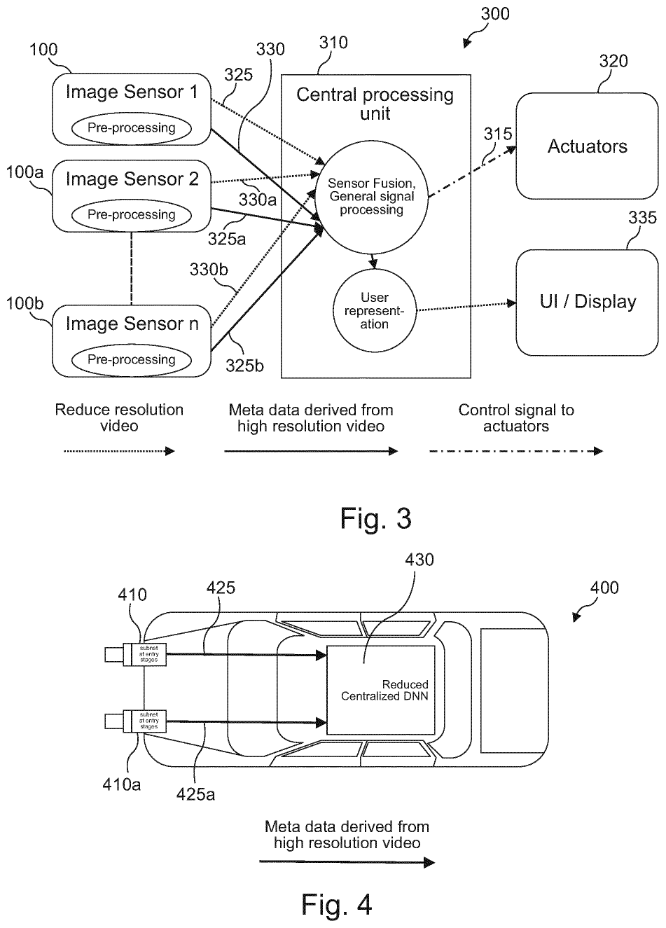

FIG. 3 shows a schematic block diagram of a system 300 comprising a plurality of sensing apparatuses 100, 100a, 100b. Each of the sensing apparatuses (e.g. semiconductor packages) 100, 100a, 100b is connected with a central processing unit 310, for example via a data bus. The system 300 may comprise an artificial neural network that is distributed between the central processing unit 310 and the plurality of sensing apparatuses 100, 100a, 100b.

For example, Meta data 325, 325a, 325b (e.g. the interpreted sensor data stream) can be sent from the sensing apparatuses 100, 100a, 100b to the central processing unit 310. The Meta data 325 may be derived from a high-resolution video stream, for example generated by an image sensor 110 of the sensing apparatuses 100, 100a, 100b, and may be pre-processed data of the neural network of the system 300. The Meta data may be further processed by a neural network of the central processing unit 310, for example to generate instructions 315 for actuators 320, for example actuators of a vehicle like a break, a motor controller and/or a steering controller. The system 300 may be part of a system of the vehicle, for example.

Further, reduced resolution video data 330, 330a, 330b (e.g. a compressed video stream) may be transmitted from the sensing apparatuses 100, 100a, 100b to the central processing unit 310. The reduced resolution video data 330, 330a, 330b may be encoded by a video coder of the central processing unit 310, for example, and may be displayed at a user interface or a display 345 of the system 300. The display 345 may be a display in a dashboard of a vehicle with the system 300, for example.

For example, other driver assistance systems perform the signal processing, e.g. for pedestrian detection, centrally. As the possible data rate that can be transmitted from the image sensors to the central unit is limited, the possible resolution and flame rate may be compromised. Due to the high real-time requirements of such systems, video is typically transmitted uncompressed. An uncompressed HD signal at 30 fps and 12 bit resolution requires a data rate of approximately 2.3 Gbps, for example. At 30 fps and an assumed vehicle speed of 50-60 km/h, in a town e.g., the vehicle drives approximately 0.5 m between two video frames. Assuming that any signal processing requires accumulating at least 3 to 4 frames before responding, this distance increases to 2 m. Additionally, the systems often enable a video representation of the outside of the car for the driver.

There are image sensors that are capable of significantly higher frame rates (e.g. up to 1000 fps) and higher resolution. Higher resolution is valuable as it allows the signal processing to distinguish objects in a larger distance from the vehicle, for example.

By providing concepts according to the present disclosure, these opposing requirements (e.g. need of high data rate sensors and limited transmission capacity) may be satisfied, e.g. by noting that the resolution required for humans is much lower than a useful resolution for machine vision, for example. The required signal processing may be split into two parts. A first part may require high-resolution sensor data and a second part may require only reduced or standard resolution data. The signal processing requiring high-resolution sensor data may be performed decentral. For example, signal processing with high resolution sensor data may be performed directly on the sensor, for example an image sensor chip, or in a package or module that comprises the image sensor. Intermediate results of this first processing part may be forwarded at significantly reduced data rate to a central processing unit, e.g. for further processing; fusion with information from other sensors, for example image sensors; output to the human user, for example processed image; and/or generating control signals for actuators, for example car breaks.

At the sensor side (e.g. within the sensing apparatus), the high frame rate and/or high dynamic range and/or high resolution video signal is e.g. sub-sampled to the data rate/format that is permissible for transmission to e.g. a head unit for displaying to the user and sent to the head unit via a low-cost standard video interface (e.g. for enabling displaying a video stream to a user); and/or is e.g. processed or partially processed at full rate e.g. by using at least a part of a neural network according to the classification and signal processing task required (e.g. denoising); and/or the result of such (e.g. decentral) processing (e.g. Meta data) is then transmitted in parallel to the reduced resolution video to the head-unit. This intermediate result (e.g. interpreted sensor data stream) may be the state of an intermediate layer of a neural network; and/or the state of an output layer of a neural network; and/or any intermediate result or output of a signal processing algorithm.

For example, the proposed scheme can be used for any sensor signals with high data rates, such as radar sensors. For this case only a reduced frame rate signal of the radar sensor is transmitted to the central unit, whereas a high rate signal is used locally to generate some intermediate output signals (e.g. detectors) that can be forwarded at lower rate, for example. For example, the scheme can also be useful in systems where some intermediate sensor fusion is performed locally. For example, an image sensor and a radar sensor are processed and/or fused locally and the intermediate result is forwarded to the central unit at lower data rate. For example, to further reduce the data rate, it may be possible to compress the video signal for transmission from the sensor to the head unit, as all time-critical information may be included in the Meta data that may be transmitted separately with a reduced time delay.

More details and aspects are mentioned in connection with the embodiments described above or below. The embodiments shown in FIG. 3 may comprise one or more optional additional features corresponding to one or more aspects mentioned in connection with the proposed concept or one or more embodiments described above (e.g. FIGS. 1-2 and 4-9) or below.

FIG. 4 shows an example of a vehicle 400 comprising a control system or driver assistance system. The vehicle 400 comprises a first sensor package 410 and a second sensor package 410 a. The sensor packages 410, 410a comprise environmental sensors. An interpreted sensor data stream 425, 425a, e.g. comprising Meta data, can be transmitted from the sensor packages 410, 410a to a central processing unit 430 of a system of the vehicle 400.

For example, both sensor packages 410, 410a each comprise a sub-network of a neural network of the control system (e.g. driver assistance system) of the vehicle. For example, compared to other systems, the central processing unit 430 may have a reduced neural network (e.g. less layers), as a part of the overall network is outsourced to the sensor packages.

More details and aspects are mentioned in connection with the embodiments described above or below. The embodiments shown in FIG. 4 may comprise one or more optional additional features corresponding to one or more aspects mentioned in connection with the proposed concept or one or more embodiments described above or below (e.g. FIGS. 1-3 and 5-9).

FIG. 5 shows an example of a vehicle 500 comprising a control system for automotive, e.g. driver assistance system, with transmission of a video stream. As shown in combination with vehicle 400, an interpreted sensor data stream 425 can be transmitted to the central processing unit 430. Additionally, a reduced resolution video stream 435, 435a can be transmitted from the sensor packages 410 to the central processing unit 430, or an additional processing unit 430a (e.g. a non-neural network based processor). For example, the reduced resolution video streams 435, 435a may be used for displaying a video to a user and/or for controlling 450 a functionality of the neural network. For example, generating driving instructions based on the reduced resolution video stream may enable the use of deterministic algorithms for autonomous driving functions, for example.

More details and aspects are mentioned in connection with the embodiments described above or below. The embodiments shown in FIG. 5 may comprise one or more optional additional features corresponding to one or more aspects mentioned in connection with the proposed concept or one or more embodiments described above or below (e.g. FIGS. 1-4 and 6-9).

FIG. 6 is a perspective view depicting a typical external configuration of a stacked image sensor, e.g. a sensing apparatus 100 comprising an image sensor 110, that may enable to provide a sensing apparatus with an integrated sensor and processing circuitry. Specifically, Subfigure A in FIG. 6 depicts a first configuration example of the stacked image sensor.

In Subfigure A in FIG. 6, the image sensor may be a complementary metal oxide semiconductor (CMOS) image sensor, for example. This is a three-layer structure image sensor. That is, the image sensor is made up of (semiconductor) substrates 610, 620 and 630 stacked in that order from the top down.

The substrate 610 has a pixel array section 611 formed thereon. The pixel array section 611 is configured to perform photoelectric conversion and have multiple pixels (not depicted) arrayed in a matrix pattern to output a pixel signal each, for example.

The substrate 620 has peripheral circuits 621 formed thereon. The peripheral circuits 621 perform various kinds of signal processing such as AD conversion of pixel signals output from the pixel array section 11.

The substrate 630 has a memory 631 formed thereon. The memory 631 functions as a storage section that temporarily stores pixel data resulting from the AD conversion of the pixel signals output from the pixel array section 611.

Subfigure B in FIG. 6 depicts a second configuration example of the stacked image sensor. Of the components in Subfigure B in FIG. 6, those whose corresponding counterparts are found in Subfigure A in FIG. 6 are designated by like reference numerals, and their explanations may be omitted hereunder where appropriate.

The image sensor in Subfigure B in FIG. 6, like its counterpart in Subfigure A in FIG. 6, has the substrate 610. It is to be noted, however, that the image sensor in Subfigure B in FIG. 6 differs from the image sensor in Subfigure A in FIG. 6 in that a substrate 640 is provided in place of the substrates 620 and 630. In Subfigure B in FIG. 6, the image sensor has a twolayer structure. That is, the image sensor has the substrates 610 and 640 stacked in that order from the top down. The substrate 640 has the peripheral circuit 621 and the memory 631 formed thereon.

More details and aspects are mentioned in connection with the embodiments described above or below. The embodiments shown in FIG. 6 may comprise one or more optional additional features corresponding to one or more aspects mentioned in connection with the proposed concept or one or more embodiments described above or below (e.g. FIGS. 1-5 and 7-9).

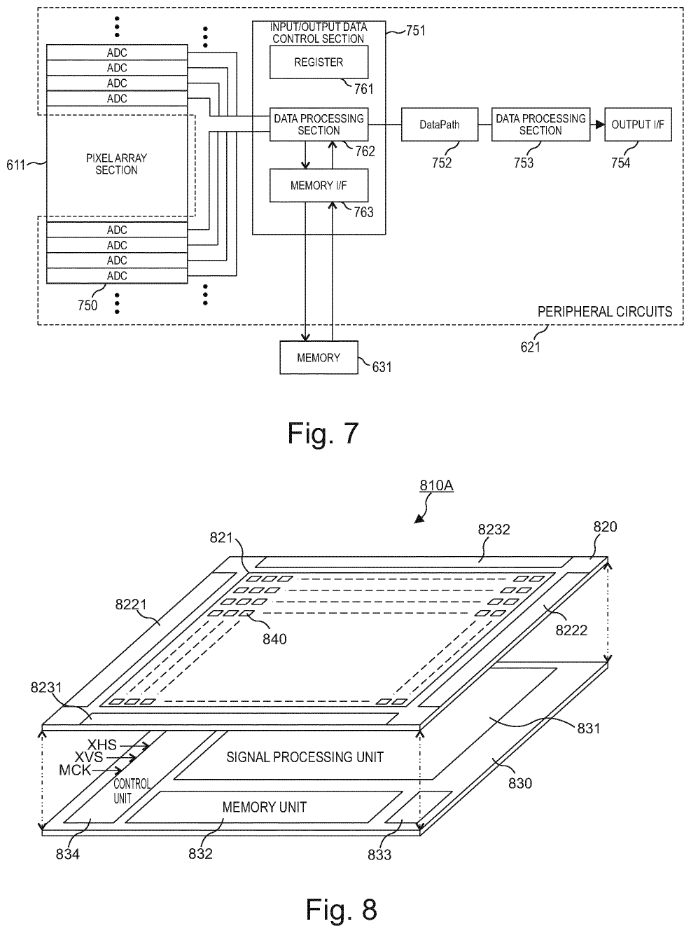

FIG. 7 shows a schematic block diagram depicting a configuration example of peripheral circuits 621 of FIG. 6. The peripheral circuits 621 include multiple AD converters (ADCs) 750, an input/output data control section 751, a data path 752, a signal processing section 753, and an output interface (I/F) 754.

There are the same number of ADCs 750 as the columns of pixels constituting the pixel array section 611. The pixel signals output from the pixels arrayed in each line (row) are subjected to parallel-column AD conversion involving parallel AD conversion of the pixel signals. The input/output data control section 751 is supplied with pixel data of a digital signal obtained per line by the ADCs 750 subjecting the pixel signals as analog signals to parallel-column AD conversion.

The input/output data control section 751 controls the writing and reading of the pixel data from the ADCs 750 to and from the memory 631. The input/output data control section 751 also controls the output of the pixel data to the data path 752. The input/output data control section 751 includes a register 761, a data processing section 762, and a memory I/F 763.

Information with which the input/output data control section 751 controls its processing is set (recorded) to the register 761 under instructions from an external device, not depicted. In accordance with the information set in the register 761, the input/output data control section 751 performs various kinds of processing.

The data processing section 762 outputs the pixel data from the ADCs 50 directly to the data path 752. Alternatively, the data processing section 762 may perform necessary processing on the pixel data supplied from the ADCs 750, before writing the processed pixel data to the memory 631 via the memory I/F 763.

Furthermore, the data processing section 762 reads via the memory I/F 763 the pixel data written in the memory 631, processes the retrieved pixel data from the memory 631 as needed, and outputs the processed pixel data to the data path 752. Whether the data processing section 762 outputs the pixel data from the ADCs 750 directly to the data path 752 or writes the pixel data to the memory 631 may be selected by setting suitable information to the register 761. Likewise, whether or not the data processing section 762 processes the pixel data fed from the ADCs 750 may be determined by setting suitable information to the register 761.

The memory I/F 763 functions as an I/F that controls writing and reading of pixel data to and from the memory 631. The data path 752 is made up of signal lines acting as a path that feeds the pixel data output from the input/output data control section 751 to the signal processing section 753.

The signal processing section 753 performs signal processing such as black level adjustment, demosaicing, white balance adjustment, noise reduction, or developing as needed on the pixel data fed from the data path 752, before outputting the processed pixel data to the output I/F 754. The output I/F 754 functions as an I/F that outputs the pixel data fed from the signal processing section 753 to the outside of the image sensor.

More details and aspects are mentioned in connection with the embodiments described above or below. The embodiments shown in FIG. 7 may comprise one or more optional additional features corresponding to one or more aspects mentioned in connection with the proposed concept or one or more embodiments described above or below (e.g. FIGS. 1-6 and 8-9).

FIG. 8 shows a schematic perspective view illustrating an exemplary configuration of a solid-state imaging device, e.g. a sensing apparatus 100. A case of a CMOS image sensor will be described as an example. However, the present disclosure is not limited to application to a CMOS image sensor.

As illustrated in FIG. 8, a solid-state imaging device 810A according to an embodiment includes a first chip (semiconductor substrate) 820 and a second chip 830 having a structure such that the first chip 820 serving as an upper-side chip and the second chip 830 serving as a lower-side chip are layered (so-called layered structure).

In the layered structure, the first chip 820 on the upper side is a pixel chip on which a pixel array unit (pixel unit) 821, configured of unit pixels 840 including a photoelectric conversion element which are two-dimensionally arranged in a matrix, is formed. On the periphery of the first chip 820, a pad 822₁ and a pad 822₂ for establishing an electrical connection with the outside, and a via 823₁ and a via 823₂ for establishing an electrical connection with the second chip 830 are provided.

While the present embodiment has a configuration in which the pad 822₁ and the pad 822₂ are provided on both left and right sides across the pixel array unit 821, it is possible to adopt a configuration in which they are provided on one of the left and right sides. Further, while the present embodiment has a configuration in which the via 823₁ and the via 823₂ are provided on both top and bottom sides across the pixel array unit 821, it is possible to adopt a configuration in which they are provided on one of the top and bottom sides. Further, it is also possible to adopt a configuration in which a pad is provided on the second chip 830 of the lower side and the first chip 820 is opened for bonding to the pad on the second chip 830 side, or a configuration in which a substrate is mounted by TSV (through silicon via) from the second chip 830.

It should be noted that a pixel signal obtained from each pixel 840 of the pixel array unit 821 is an analog signal, and the analog pixel signal is transmitted from the first chip 820 to the second chip 830 through the vias 823₁ and 823₂.

The second chip 830 on the lower side is a circuit chip on which in addition to a driving unit (not shown) for driving the respective pixels 40 of the pixel array unit 821 formed on the first chip 820, peripheral circuitry including a signal processing unit 831, a memory unit 832, a data processing unit 833, a control unit 834, and the like are formed.

The signal processing unit 831 performs predetermined signal processing including digitization (AD conversion) on an analog pixel signal read from each pixel 840 of the pixel array unit 821. The memory unit 832 stores pixel data on which predetermined signal processing is performed by the signal processing unit 831. The data processing unit 833 performs processing to read pixel data, stored in the memory unit 832, in a predetermined sequence, and output it to the outside of the chip.

The control unit 834 controls respective operations of the driving unit described above, and the peripheral circuitry such as the signal processing unit 831, the memory unit 832, and the data processing unit 833, based on a horizontal synchronization signal XHS, a vertical synchronization signal XVS, and a reference signal such as a master clock MCK, provided from the outside of the chip, for example. In that respect, the control unit 834 controls the circuit (pixel array unit 821) on the first chip 820 side and the circuits (the signal processing unit 831, the memory unit 832, and the data processing unit 833) on the second chip 830 side in synchronization with each other.

As described above, in the solid-state imaging device 810A configured of the layered first chip 820 and the second chip 830, as the first chip 820 only needs a size (area) on which the pixel array unit 821 can be formed, the size (area) of the first chip 820, and further, the size of the entire chip can be small. Moreover, as it is possible to apply a process suitable for creating the pixels 840 to the first chip 820 and a process suitable for creating circuits to the second chip 830, respectively, there is also an advantage that the processes can be optimized in manufacturing the solid-state imaging device 810A.

Further, while an analog pixel signal is transmitted from the first chip 820 side to the second chip 830 side, with the configuration in which circuitry for performing analog and digital processing are formed on the same substrate (second chip 830) and with the configuration in which the circuits on the first chip 820 side and the circuits on the second chip 830 side are controlled in synchronization with each other, it is possible to realize high-speed processing. Incidentally, in the case of adopting a configuration of transmitting a pixel signal as digital data between different chips, a clock delay is caused due to an effect of parasitic capacity or the like, which prevents high-speed processing.

More details and aspects are mentioned in connection with the embodiments described above or below. The embodiments shown in FIG. 8 may comprise one or more optional additional features corresponding to one or more aspects mentioned in connection with the proposed concept or one or more embodiments described above or below (e.g. FIGS. 1-7 and 9).

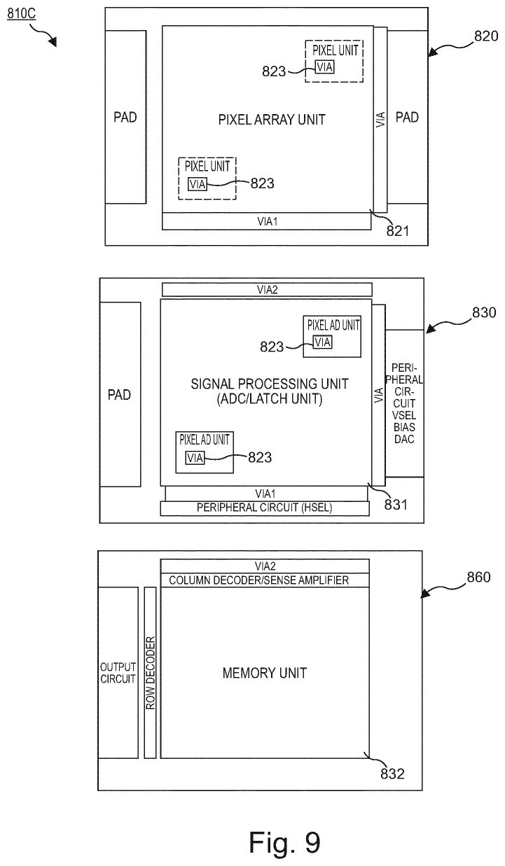

FIG. 9 is a layout diagram illustrating another exemplary layout of a layered chip in a solid-state imaging device 810C according to an embodiment.

While the above-described exemplary layout adopts a layered structure of having two layers in which two chips, namely the first chip 820 and the second chip 830, are layered, the present exemplary layout adopts a layered structure having three layers in which three chips, namely the first chip 820, the second chip 830, and a third chip 860, are layered. However, the present embodiment is not limited to a layered structure having three layers, and a layered structure having four or more layers is also acceptable.

As illustrated in FIG. 9, the present exemplary layout has a structure in which the pixel array unit 821 is disposed on the first chip 820, circuitry (in the drawing, pixel AD unit) including the AD converter is disposed on the second chip 830, the memory unit 832 is disposed on the third chip 860, which are laminated such that the second chip 830 is placed in the middle, for example. It should be noted that while the layered sequence of the first chip 820, the second chip 830, and the third chip 860 is arbitrary, it is preferable to place the second chip 830, on which the circuitry including the control unit 834 is mounted, in the middle because the first chip 820 and the third chip 860, to be controlled by the control unit 834, locate immediately above and immediately below the second chip 830.

As in the present exemplary layout, by adopting a configuration in which the memory unit 832 is provided on the third chip 860 which is a chip other than the second chip 830 on which the circuitry including the AD converter and the like and the peripheral circuitry in eluding the control unit 834 are provided, it is possible to reduce the chip area, compared with the exemplary layout in which the memory unit 832 is provided on the second chip 830. In that case, a configuration in which the second chip 830 on which the circuitry including the AD converter and the like is mounted and the third chip 860 on which the memory unit 832 and the like are mounted are connected with each other using a via (via 2) is considered. The vias (via 1/via 2) allowing an electrical connection between the chips can be realized by a well-known inter-wiring bonding technique.

According to the solid-state imaging device 810C, as readout speed of pixel signals can be faster by using a pixel-parallel AD conversion method, it is possible to take a longer stopped period of the AD converter. Accordingly, it is possible to further reduce the power consumption compared with the case of the solid-state imaging device 810A according to the embodiment using a column-parallel AD conversion method.

Further, the solid-state imaging device 810C according to the present embodiment adopts a configuration in which the memory unit 832 is provided outside the signal processing unit 831, which is different from the solid-state imaging device on another embodiment in which both the AD converter and the memory unit 832 are provided together in the signal processing unit 831. Thereby, the solid-state imaging device 810C according to the present embodiment is adaptable to a case where it is difficult to realize well isolation of an analog circuit such as DRAM and the memory unit 832.

In each of the embodiments described above, while description has been given on the case of applying the technology to a solid-state imaging device having a layered structure as an example, the technology of the present disclosure is not limited to application to a solid-state imaging device having a layered structure. That is, a technology of performing low-speed readout by intermittent driving, in which operation of the current source and operation of at least the AD converter of the signal processing unit 831 are stopped at the time of readout of pixel data from the memory unit 832, is also applicable to a so-called flat-type solid-state imaging device formed such that the pixel array unit 821 and the peripheral circuits thereof are arranged on the same substrate (chip).

However, as the solid-state imaging devices of the embodiment use a pixel-parallel AD conversion method, it can be said that a solid-state imaging device having a layered structure is preferable because it is able to adopt a connection structure in which a pixel unit of the pixel array unit 821 and a pixel AD unit of the signal processing unit 831 can be directly connected through the via 823.

A solid-state imaging device to which the technology of the present discourse is applicable can be used as an imaging unit (image capturing unit) in electronic equipment in general including imaging devices such as a digital still camera and a video camera, a mobile terminal device having an imaging function such as a mobile telephone, a copying machine using a solid-state imaging device for an image reading unit, and the like. It should be noted that there is a case where a mode in the above-described module state to be mounted on electronic equipment, that is, a camera module, is used as an imaging device.

More details and aspects are mentioned in connection with the embodiments described above or below. The embodiments shown in FIG. 9 may comprise one or more optional additional features corresponding to one or more aspects mentioned in connection with the proposed concept or one or more embodiments described above or below (e.g. FIG. 1-8).

Examples of the disclosure relate to decentralized sensor networks, e.g. comprising image sensors, for machine vision applications, for example for applications in vehicles. A decentralized neural network may bring advantages relating to a quality of data processed by the neural network and/or a relating to an amount of data to be transmitted between separate units of the decentralized network.

The following examples pertain to further embodiments.
(1) A sensing apparatus, comprising: a sensor configured to generate a sensor data stream having a first data rate; a data processing circuitry configured to interpret the sensor data stream to generate an interpreted sensor data stream having a second data rate lower than the first data rate as a pre-processed data for a process based on an artificial neural network at a central processing apparatus; and a transmitter configured to transmit the interpreted sensor data stream from the sensing apparatus to the central processing apparatus.
(2) The sensing apparatus according to (1), wherein the sensor comprises one of an image sensor, a multi-spectral sensor, a polarized image sensor, a time-of-flight sensor, a radar sensor, and a lidar sensor.
(3) The sensing apparatus according to (1) or (2), wherein at least the sensor and a circuit comprising at least one first layer of the artificial neural network are integrated in a common semiconductor chip.
(4) The sensing apparatus according to one of (1) to (3), wherein the interpreted sensor data stream is configured for use in a machine vision application.
(5) The sensing apparatus according to one of (1) to (4), wherein the sensor data is image based information, and the interpreted sensor data stream includes information on an object from the image based information.
(6) The sensing apparatus according to one of (1) to (5), wherein the sensor data is at least one of radar based information, lidar based information, polarized image sensor information, multispectral image sensor information, and time-of-flight-sensor based information, and the interpreted data stream includes information on an object from the at least one of radar based information, lidar based information, polarized image sensor information, multispectral image sensor information, and time-of-flight-sensor based information.
(7) The sensing apparatus according to one of (1) to (6), wherein the interpreted sensor data stream comprises information relating to at least one region of interest of the original sensor data.
(8) The sensing apparatus according to one of (1) to (7), wherein the second data rate is less than 40% of the first data rate.
(9) The sensing apparatus according to one of (1) to (8), wherein the data rate of the sensor data stream is at least 7 Gbit/s and/or a frame rate of the sensor is at least 50 frames per second and/or a resolution of the sensor is at least 6 megapixels.
(10) The sensing apparatus according to one of (1) to (9), wherein the sensor is configured to provide a video stream and a video coder of the sensing apparatus is configured to reduce a quality of the video stream, wherein the sensing apparatus is configured to transmit the encoded video stream additionally to the interpreted sensor data stream.
(11) The sensing apparatus according to one of (1) to (10), further comprising a data compression unit located in a signal path between the artificial neural network and the transmitter, wherein the data compression unit is configured to further compress the data rate of the interpreted sensor data stream.
(12) A control system for automotive comprising at least one sensing apparatus according to one of the previous examples (1) to (11); and a central processing device connected to the sensing apparatus via a data bus for receiving at least the interpreted sensor data stream from the sensing apparatus, wherein the central processing device is configured to generate a driving instruction based on at least one interpreted sensor data stream.
(13) The control system for automotive according to (12), further comprising a neural network comprising at least two sub-networks, wherein the artificial neural network of the sensing apparatus is provided as a first sub-network of the neural network of the system, wherein a second sub-network of the neural network is provided in the central processing device.
(14) The control system for automotive according to (13), further comprising: a plurality of sensing apparatuses according to one of the previous claims, wherein the neural network comprises a plurality of sub-networks, wherein each of the sensing apparatuses comprises a sub-network of the neural network.
(15) The control system for automotive according to (13) or (14), wherein the central processing device comprises at least two processors, wherein each of the processors of the central processing device comprises a sub-network of the neural network.
(16) The control system for automotive according to one of (12) to (15), e.g. comprising a display, wherein the sensing apparatus comprises an image sensor configured to provide a high quality video stream, wherein the sensing apparatus is configured to output a reduced quality video stream based on the high quality video stream, wherein the system is configured to show the reduced quality video stream on the display.
(17) The control system for automotive according to one of (12) to (16), wherein the system comprises at least one neural network based processing circuitry, and at least one logical processing circuitry.
(18) A vehicle comprising a sensing apparatus and/or a control system for automotive according to one of the previous claims.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A sensing apparatus, comprising:
a sensor configured to generate a sensor data stream having a first data rate;
a data processing circuitry configured to interpret the sensor data stream to generate an interpreted sensor data stream having a second data rate lower than the first data rate as a pre-processed data for a process based on an artificial neural network at a central processing apparatus; and
a transmitter configured to transmit the interpreted sensor data stream from the sensing apparatus to the central processing apparatus.

2. The sensing apparatus according to claim 1,
wherein the sensor comprises one of an image sensor, a multi-spectral sensor, a polarized image sensor, a time-of-flight sensor, a radar sensor, and a lidar sensor.

3. The sensing apparatus according to claim 1,
wherein at least the sensor and a circuit comprising at least one first layer of the artificial neural network are integrated in a common semiconductor chip.

4. The sensing apparatus according to claim 1,
wherein the interpreted sensor data stream is configured for use in a machine vision application.

5. The sensing apparatus according to claim 1,
wherein the sensor data is image based information, and the interpreted sensor data stream includes information on an object from the image based information.

6. The sensing apparatus according to claim 1,
wherein the interpreted sensor data stream comprises information relating to at least one region of interest of the original sensor data.

7. The sensing apparatus according to claim 1
wherein the second data rate is less than 40% of the first data rate.

8. The sensing apparatus according to claim 1,
wherein the data rate of the sensor data stream is at least 7 Gbit/s and/or a frame rate of the sensor is at least 25 frames per second and/or a resolution of the sensor is at least 6 megapixels.

9. The sensing apparatus according to claim 1,
wherein the sensor is configured to provide a video stream and a video coder of the sensing apparatus is configured to reduce a quality of the video stream, wherein the sensing apparatus is configured to transmit the encoded video stream additionally to the interpreted sensor data stream.

10. The sensing apparatus according to claim 1, further comprising
a data compression unit located in a signal path between the artificial neural network and the transmitter, wherein the data compression unit is configured to further compress the data rate of the interpreted sensor data stream.

11. A control system for automotive comprising:
at least one sensing apparatus according to one of the previous claims; and
a central processing device connected to the sensing apparatus via a data bus for receiving at least the interpreted sensor data stream from the at least one sensing apparatus,
wherein the central processing device is configured to generate a driving instruction based on the at least one interpreted sensor data stream.

12. The control system for automotive according to claim 11, further comprising
a neural network comprising at least two sub-networks, wherein the artificial neural network of the sensing apparatus is provided as a first sub-network of the neural network of the system, wherein a second sub-network of the neural network is provided in the central processing device.

13. The control system for automotive according to claim 12, further comprising:
a plurality of sensing apparatuses according to one of the previous claims, wherein the neural network of the control system for automotive is a distributed neural network comprising a plurality of sub-networks, wherein each of the sensing apparatuses comprises a sub-network of the neural network.

14. The control system for automotive according to claim 12,
wherein the central processing device comprises at least two processors, wherein a first of the at least two processors comprises a sub-network of the neural network, wherein a second of the at least two processors does not comprise a neural network.

15. The control system for automotive according to claim 11,
wherein the sensing apparatus comprises an image sensor configured to provide a high quality video stream, wherein the sensing apparatus is configured to output a reduced quality video stream based on the high quality video stream, wherein the system is configured to show the reduced quality video stream on a display.
